(19) United States
(12) Patent Application Publication
(10) Pub. No.: US 2009/0097852 A1
(43) Pub. Date: Apr. 16, 2009

(54) 10 Gbps OFDMA-PON

(75) Inventors: Dayou QIAN, Plainsboro, NJ (US); Ting WANG, West Windsor, NJ (US); Junqiang HU, Princeton, NJ (US); Philip JI, Princeton, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 12/241,991

(22) Filed: Sep. 30, 2008

Related U.S. Application Data
(60) Provisional application No. 60/978,306, filed on Oct. 8, 2007.

(51) Int. Cl. H04J 14/08

(52) U.S. Cl. 398/89

(57) ABSTRACT

A method for generating transparent pipes for heterogeneous service transmission via OFDMA-PON. In an exemplary embodiment, dedicated sub-channels, which are composed of one or more subcarriers—are used as a “transparent pipe” for delivery of arbitrary analog or digital signals for both circuit switched and packet switched systems.

### CROSS REFERENCE TO RELATED APPLICATIONS

This application claims the benefit under 35 U.S.C. § 119(e) of U.S. Provisional Application No. 60/978,306, filed Oct. 8, 2007, the entire contents and file wrapper of which are hereby incorporated by reference for all purposes into this application.

### FIELD OF THE INVENTION

This invention relates generally to the field of telecommunications. More particularly, it pertains to optical networking including passive optical networks and a method for generating transparent paths for heterogeneous service transmission through Orthogonal Frequency Division Multiple Access—Passive Optical Network (OFDMA-PON).

### BACKGROUND INFORMATION

Next generation optical access networks will necessarily deliver heterogeneous services to multiple customers simultaneously. Such services will likely include legacy T1/E1, backbone cellular, layer-2 VPN, as well as security channels for storage networks —among others.

Time division multiplexed (TDM) based networks such as GE-PON and 10G-PON require relatively complex scheduling algorithms and framing technologies to support a number of different services. As can be readily understood, the performance of such networks is highly sensitive to the latency of packet transmission which can be affected by other traffic using the same links of the network. However, multiple wavelengths require multiple transceivers and arrayed-waveguide gratings (AWG) or optical filters to distribute wavelengths to correct receivers thereby increasing overall system cost and complexity. In addition, WDM-PONs generally lack the ability to dynamically allocate the wavelength resource among different services.

### SUMMARY OF THE INVENTION

In an exemplary embodiment, the present invention is directed to an apparatus and accompanying method for generating transparent pipes for heterogeneous service transmission via OFDMA-PON. In an exemplary embodiment, dedicated sub-channels, which are composed of one or more subcarriers—are used as a “transparent pipe” for delivery of arbitrary analog or digital signals for both circuit switched and packet switched systems.

In this exemplary embodiment, simultaneous orthogonal sub-carriers are employed and combine OFDM and Time Division Multiple Access in a manner in which the sub-carriers (OFDM) are dynamically assigned to services in different time slots. The modulated data streams are orthogonal to each other in the frequency domain, resulting in the elimination of cross-talk. By removing some sub-carriers, “transparent pipes” may be placed within the overall OFDMA signal bandwidth which may then be used to transmit services independently of one another.

The aforementioned and other features and aspects of the present invention are described in greater detail below.

### BRIEF DESCRIPTION OF THE DRAWING

FIG. 1 illustrates an OFDMA-PON having transparent pipes for multiple services according to the present invention;

FIG. 2 illustrates a digitized/packet data only ONU architecture;

FIG. 3 illustrates an analog/RF signal only ONU architecture;

FIG. 4 illustrates analog/RF signal and digitized/packet data mixed ONU architecture;

FIG. 5 illustrates OLD architecture;

FIG. 6. illustrates an overall architecture of an OFDMA-PON according to the present invention.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

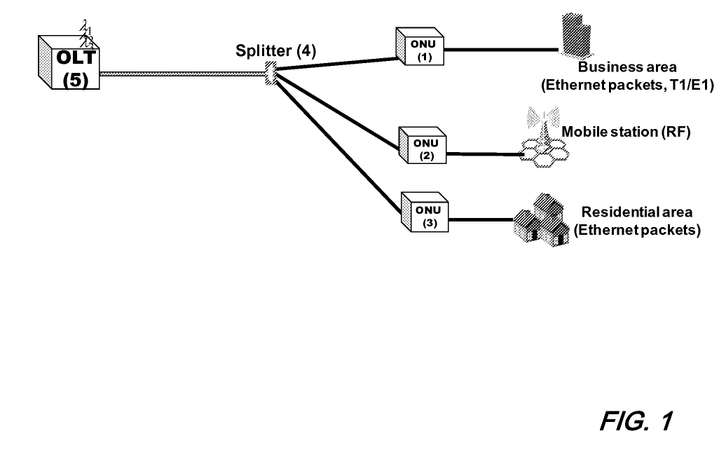

By way of some additional background and with initial reference to FIG. 1, it may be appreciated that in an OFDMA-PON, the overall bandwidth is divided into orthogonal sub-carriers. Each individual ONU (1, 2, 3) is allocated with one sub-channel including one or more sub-carriers. Importantly some of the sub-carriers can be reserved for specific services like radio over fiber for wireless base stations.

With continued reference to that FIG. 1 there it shows the OFDMA-PON with the transparent pipes for multiple services. Dedicated sub-carriers are reserved at all ONUs to generate two transparent pipes for the legacy TDM service at business area ONU (1) and the RF radio signal from the mobile base station ONU (2). Advantageously, both TDM and radio signals are used to drive optical modulators directly without any further processing.

The number of sub-carriers of each transparent pipe depends on the bandwidth required by the service. The remaining sub-carriers are allocated to packet-based IP traffic, shared by all packet-based ONU-s (1, 3) both in frequency and time domain. The sub-carriers and time slots allocation are controlled by the OLT (5) and sent to the ONUs over non-reserved sub-carrier in the pre-configured time slots.

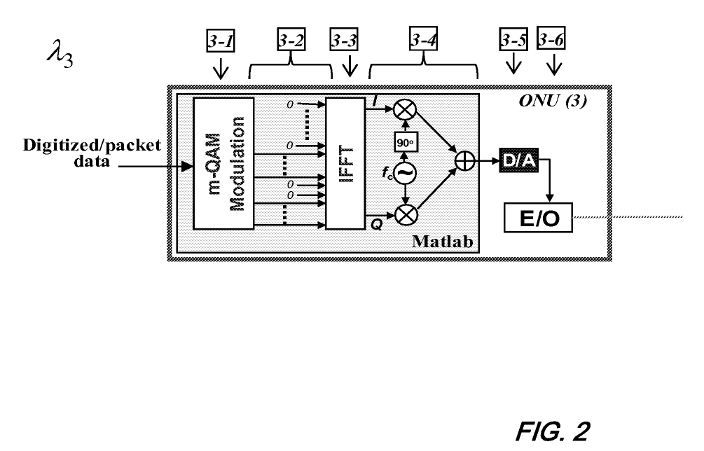

With reference now to FIG. 2, there is shown a block diagram illustrating digitized/packet data only ONU architecture. As can be observed from this FIG. 2, for upstream traffic, digitized/packet data is received at m-QAM modulator (3-1) first. The digitized/packet data ONU (3) maps the modulated digitized signal or packet data to the given sub-carrier(s) and sets all the other sub-carriers to zero (3-2).

The IFFT (3-3) and the IQ-mixer (3-4) complete the modulation to generate an OFDM frame which contains the same number of OFDM symbols as the number of total sub-carriers in the time domain. The OFDM frame is then converted into optical OFDM symbols with digital/analog converter (D/A) (3-5) and electrical/optical converter (E/O) (3-6) at different wavelengths following the schedule pre-decided by the OLT (5) and transmitted out over fiber at a particular wavelength.

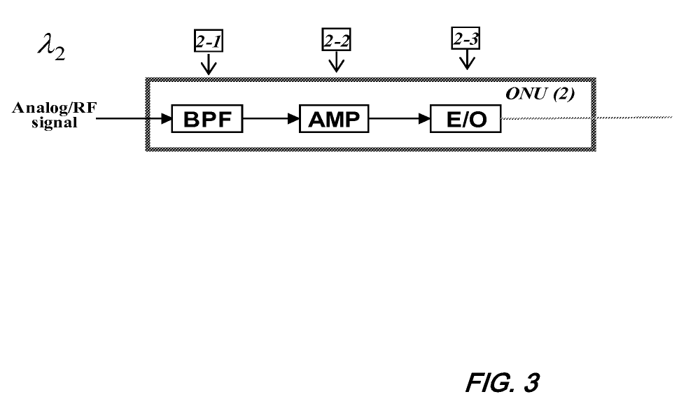

With reference to FIG. 3, it may be observed that for an upstream analog signal, the signal is filtered through the effect of a band-pass filter (2-1) and then amplified through the effect of amplifier (2-2). Then the ONU (2) uses the amplified analog/RF signal to drive the electrical/optical (E/O) module (2-3) and generate optical radio signals. Because the frequency band of this optical radio signal has been reserved at other ONUs, it will not overlap with any other signals and can be transmitted through OFDMA-PON transparently.

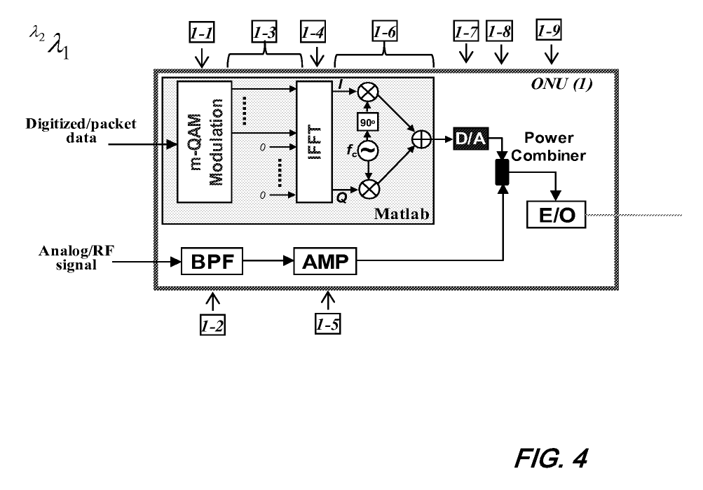

Turning now to FIG. 4, it may be observed that when the ONU (1) has mixed analog and digitized upstream traffic, the analog and digitized signal(s) are processed separately and combined at the end using analog combiner (1-8). The combined analog signals would be used to drive the E/O module and generate optical upstream signals.

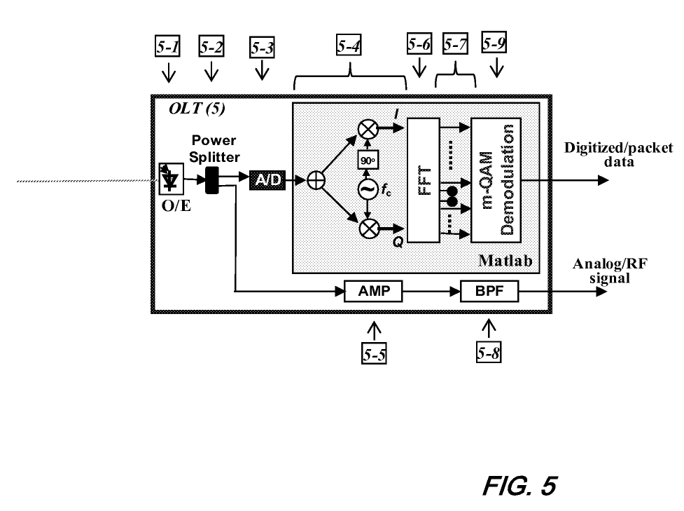

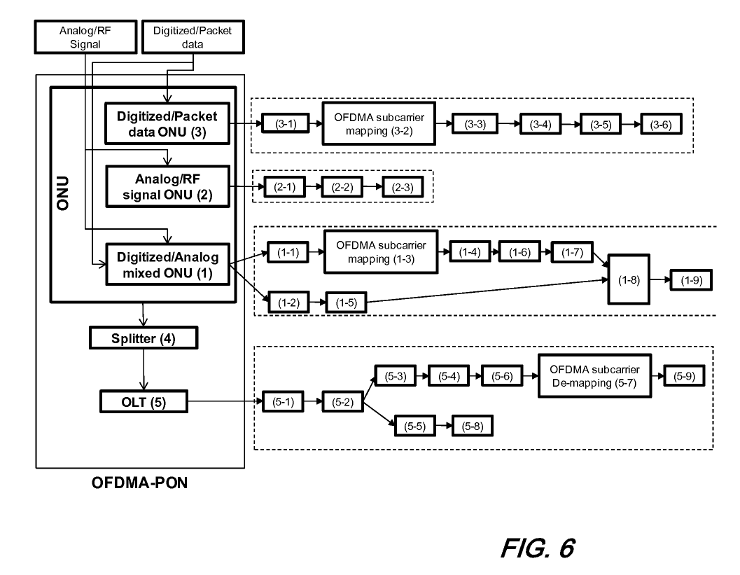

FIG. 5 shows the overall OLT architecture. FIG. 6 shows the OFDMA-PON architecture overall operation. With simultaneous reference to that FIG. 5 and FIG. 6, it may be seen that optical OFDM symbols from multiple ONUs (1, 2, 3) are combined by the optical coupler/splitter (4), forming a single OFDM frame, and detected by a single photo-detector (5-1) at the OLT receiver (5).

The analog electrical signals after the O/E (5-1) are split by a power splitter (5-2). All the analog signals through the transparent pipes can be easily identified by passing one splitter output through electrical band-pass filters (5-8). Advantageously, and due to the orthogonal nature, the interference from other ONU-s can be minimized.

For the digitized/packet data, the other output of the splitter is digitized by the A/D (5-3) first. Then the IQ-demux (5-4), FFT (5-6) and m-QAM demodulation (5-9) will recover the data. The OFDMA sub-carrier de-mapping (5-7) has to follow the same rule as the OFDMA sub-carrier mapping (3-2 or 1-3) at the ONU side for the correct data recovery. Different wavelength is required for each ONU to avoid beating noise.

For downstream traffic, the OLT reserved some sub-carriers for transparent pipes and encapsulates the packet-based data into the rest sub-carriers and time slots according to the frequency and time domain scheduling results. The OFDM frame and other analog signals would be mixed by the electrical coupler to drive optical modulator which is similar to the digitized/analog signals mixed ONU-s. When the mixed signal reaches the ONU-s, each ONU picks out its own data or signal from the proper sub-carrier(s), pipes and time slots.

The OFDMA-PON provides the capability to embed other analog/RF signal into its own broadband OFDMA signal in frequency domain by using the specific OFDMA sub-carrier mapping. Some frequency band can be reserved as empty so that transparent pipes could be generated which are used to delivery any analog/RF signals. This technology is realized by the OFDMA-PON architecture and the OFDAM sub-carrier mapping/de-mapping.

As can be now appreciated, the OFDMA-PON architecture must generate the embedded transparent analog/RF signal pipes. The OFDMA sub-carrier mapping (3-2, 1-3) and the de-mapping (5-7) are two very important steps in the method.

Finally, it is understood that the above-described embodiments are illustrative of only a few of the possible specific embodiments which can represent applications of the invention. Numerous and varied other arrangements can be made by those skilled in the art without departing from the spirit and scope of the invention.

What is claimed is:

1. An Orthogonal Frequency Division Multiple Access-Passive Optical Network (OFDMA-PON) system comprising:
an optical line terminal (OLT);
a plurality of optical networking units (ONUs) in optical communication with the OLT through the effect of one or more splitters; and
CHARACTERIZED IN THAT:
a set of dedicated sub-channels which consist o one or more sub-carriers are used as a transparent pipe of the delivery of arbitrary analog or digital signals for both circuit switched and packet switched systems modeling a normal behavior of the system.
